(19) United States
(12) Patent Application Publication
(10) Pub. No.: US 2026/0288248 A1
(43) Pub. Date: Sep. 24, 2026

(54) LIFE Vision One Multi-Modal Wearable Augmented-Reality Computing System

(71) Applicant: Shekeema Friend, Atlanta, GA (US)

(72) Inventor: Shekeema Friend, Atlanta, GA (US)

(21) Appl. No.: 19/411,309

(22) Filed: Dec. 7, 2025

(51) Int. Cl. G06F 3/01; G02B 27/01; G06F 1/16; G06T 11/00

(52) U.S. Cl. CPC G06F 3/017; G02B 27/0172; G06F 3/013; G06T 11/00; G02B 2027/0174; G06F 1/163

(57) ABSTRACT

A wearable augmented-reality computing system integrates an adaptive optical subsystem, multimodal sensor-fusion engine, biometric authentication, gesture-interaction framework, proximity-verified encrypted communication protocol, and autonomous emergency-response subsystem. The head-mounted display provides dynamic transparency control and waveguide-based AR projection. A biometric identity engine authenticates the user through ocular, vascular, or behavioral signals. A sensor-fusion processor generates a unified environmental model from optical, depth, motion, environmental, and accessory inputs. A gesture-recognition system interprets micro-gestures, ring-based vectors, and spatial-stylus motion. Secure communication is established only after verified gestures, biometric confirmation, and a proximity threshold. Emergency capabilities include distress detection, silent SOS activation, hazard-aware routing, survival-mode power allocation, and authenticated responder access. The system further supports cloud-assisted neural rendering, modular sensor expansion, and distributed multi-user mapping to enhance safety, communication, and real-time AR operation.

### CROSS-REFERENCE TO RELATED APPLICATIONS

This application claims the benefit of U.S. Provisional Patent Application No. 63/927,533, filed on Nov. 29, 2025, titled AI-Enabled Cellular Smart Glasses With Integrated Optical Display, On-Device AI Processing, and NFC Subsystem. The entire contents of that provisional application are hereby incorporated by reference.

### FIELD OF THE INVENTION

The present disclosure relates to wearable computing devices, augmented-reality (AR) systems, sensor-fusion architectures, biometric authentication engines, gesture-based input systems, proximity-verified encrypted communication, emergency-response automation, and distributed cloud-connected computing ecosystems.

More particularly, the invention concerns a multi-modal wearable AR platform that integrates: adaptive optical rendering,
multi-signal biometric identity mapping,
gesture-initiated secure exchanges,
proximity-encrypted communication,
intelligent hazard-aware processing,
modular accessory integration, and
real-time distributed intelligence.

### BACKGROUND OF THE INVENTION

Existing wearable AR systems suffer significant functional limitations:

### 1. Weak or Incomplete Biometric Authentication

Most AR and smart-glasses products rely on limited biometrics (e.g., iris scan only, or no biometric loop at all).
This exposes devices to unauthorized use, spoofing, and coercion.

### 2. Fragmented Sensor Fusion

Conventional systems often process camera, IMU, environmental, and biometric data in isolation, causing:
unstable AR overlays,
poor hazard detection,
reduced gesture accuracy, and
delayed environmental interpretation.

### 3. Manual or Unsafe Interaction Methods

Many devices require:
handheld controllers,
touchpads, or
explicit manual input
   making them unusable during emergencies, multitasking, or hands-free environments.

### 4. No Proximity-Verified Secure Communication

Standard wireless channels (Bluetooth/Wi-Fi) cannot confirm physical proximity or user intent.

This creates security risks such as:
relay attacks,
unauthorized pairing, and
invisible data-interception events.

### 5. Insufficient Emergency-Mode Intelligence

Conventional wearables lack:
biometric distress detection,
motion-based emergency triggers,
hazard-aware escape routing,
silent SOS channels,
responder authentication, or
survival-state fallback power.

### 6. Rigid Architecture With No Modular Sensor Expansion

Existing systems cannot accept new sensors, medical modules, or tactical attachments without:
major redesign,
unsafe driver access, or
firmware modification.

### 7. Lack of Distributed Cloud-Assisted Intelligence

Most head-mounted devices operate as isolated units, limiting:
neural rendering,
hazard prediction accuracy,
spatial-memory persistence, and
multi-user or team-based interaction.

These deficiencies make today s AR systems unreliable for:
medical use,
tactical missions,
industrial operations,
emergency response,
personal safety, and
secure close-range communication.

The present invention solves these problems through an integrated, multi-modal, AI-driven wearable system built for reliability, safety, authentication, and secure communication.

### SUMMARY OF THE INVENTION

The present invention introduces LIFE Vision One, a unified augmented-reality computing system that integrates:

### (i) Adaptive Optical System (LIFE Lens)

Dynamic transparency, AR overlay control, hazard-triggered forced transparency, and thermal regulation.

### (ii) POIMS—Poly-Observable Identity Mapping System

A multi-signal, continuous biometric authentication engine using:
ocular-pattern mapping,
blink-behavior modeling,
micro-movement analysis,
vascular-light signatures, and
consciousness-state inference.

This creates a non-spoofable rolling identity-verification loop.

### (iii) GIPEP—Gesture-Initiated, Proximity-Encrypted Protocol

A communication system requiring:
a verified gesture,
proximity threshold, and
biometric authentication
before establishing encrypted peer-to-peer communication.

### (iv) Multimodal Sensor—Fusion Engine

A unified environmental-interpretation pipeline merging:
optical cameras,
depth sensors,
IMUs,
environmental modules, and
biometric signals
into a single, synchronized spatial map.

### (v) Emergency & Autonomous Safety Subsystem

Including:
distress-signal detection,
silent SOS gestures,
fall/impact recognition,
hazard-aware routing,
responder authentication, and
survival-state power management.

### (vi) Gesture-Interaction Ecosystem

Supporting inputs from:
frame-mounted gesture cameras,
LIFE Ring motion vectors,
AirPen 3D trajectory input,
micro-gesture sensors.

### (vii) Distributed Cloud-Connected Intelligence

Enabling:
offloading high-load neural inference tasks,
multi-device synchronization,
team-mapping overlays,
hazard-prediction augmentation, and
secure profile portability.

### (viii) Modular Accessory & Sensor Expansion Bus

Supporting hot-swappable:
medical sensors,
night-vision modules,
tactical attachments,
industrial measurement modules,
extended environment-monitoring tools.

Together, these elements form the first holistic, safety-driven, proximity-verified, continuously authenticated AR computing system.

### INVENTIVE CONCEPTS

The inventions core inventive concepts include:

### 1. POIMS-Predictive Ocular & Identity Mapping System

A multi-signal biometric engine that continuously authenticates the user.

### 2. GIPEP-Gesture-Initiated Proximity-Encrypted Protocol

A secure communication method requiring verified user gesture+proximity+biometric identity to exchange data.

### 3. Adaptive Life Lens Optical System

A lens layer with autonomous transparency modulation and hazard-aware forced-visibility logic.

### 4. Neural-Rendering Engine

A real-time inference engine capable of predictive hazard modeling, spatial awareness, and AR alignment.

### 5. Emergency Automation Core (SERS)

An autonomous safety engine with silent-SOS capability, hazard identification, motion collapse detection, and survival routing.

### 6. Modular Sensor-Expansion Architecture

Hot-swappable expansion ports enabling new sensors and modules without compromising system security.

### 7. Cloud-Distributed Inference & Multi-Device Orchestration

A cloud-augmented intelligence system that supports real-time shared maps, team overlays, navigation, and hazard detection.

### BRIEF DESCRIPTION OF THE DRAWINGS

The drawings referenced below illustrate exemplary embodiments of the disclosed wearable augmented-reality system. The figures depict structural components, system architectures, gesture pathways, biometric engines, communication protocols, emergency subsystems, and navigation/hazard-detection frameworks. The drawings are not to scale and may be simplified for conceptual clarity.

FIG. 1—System Architecture Overview

A high-level block diagram illustrating the major components of the LIFE Vision One system, including:
processing module(s),
adaptive LIFE Lens optical subsystem,
POIMS biometric-sensor array,
environmental and depth-camera stack,
sensor-fusion engines,
gesture-recognition modules,
proximity-verified communication subsystem (GIPEP),
emergency-response core,
wireless communication interfaces, and
cloud-integration architecture.

FIG. 2—Operating Environment & Software Architecture

A system-level functional diagram showing the interaction of:
LIFENode OS,
neural-rendering pipeline,
gesture routing framework,
biometric/authentication loops,
sensor-fusion engines,
wireless communication layers, and
safety override pathways.

FIG. 3—Multimodal Sensor-Fusion Pipeline

A flow diagram illustrating:
depth sensors,
RGB cameras,
IMU data,
environmental sensors,
biometric sensors,
auxiliary accessory inputs (LIFE Ring, AirPen), and
the temporal-synchronization engine that merges these into a unified environmental model.

FIG. 4—Proximity-Based Communication Engine (GIPEP)

Depicts:
gesture-trigger detectors,
proximity threshold measurement,
biometric confirmation loop (POIMS),
dynamic key-generation module,
encrypted packet exchange pathways,
NFC/UWB antennas enabling proximity validation.

FIG. 5—Adaptive Optical System (LIFE Lens)

Illustrates:
variable-opacity layers,
holographic waveguides,
AR injection rails,
thermal stabilization layers,
forced-transparency safety override pathways,
eye-tracking and alignment sensors.

FIG. 6—LIFENode OS/Runtime Environment

Shows:
real-time kernel layers,
sandboxed application space,
biometric-gated permissions,
distributed inference interfaces,
gesture-interaction handlers,
emergency-mode override engine.

FIG. 7—Emergency-Response & Safety System (SERS)

Illustrates:
biometric distress detection,
silent-SOS gesture channels,
fall/motion anomaly detection,
hazard-aware routing engine,
responder-authentication module,
communication fail-safe layers.

FIG. 8—NFC, UWB, and Short-Range Communication Hardware

Shows:
antenna positioning within the temple frame,
proximity-exchange antennas,
short-range communication coils,
encrypted identity chip placement,
accessory-pairing interfaces.

FIG. 9—Gesture-Recognition & Multi-Input Interaction Pipeline

Depicts:
frame-mounted gesture sensors,
micro-gesture detection,
LIFE Ring gesture vectors,
AirPen 3D trajectory capture,
neural gesture-interpretation model,
unified intent-mapping engine.

FIG. 10—Power Architecture, Distribution, and Thermal Governance

Illustrates:
curved micro-cell batteries,
emergency reserve cell,
inductive charging coils,
thermal-management pathways,
power-governance controller,
survival-mode operation circuitry.

FIG. 11—Emergency-Response Workflow

A flowchart showing:
trigger detection (biometric, gesture, motion, environmental),
intent-verification state,
escalation levels (1-4),
SOS broadcast channels,
survival routing activation,
responder verification and secure data sharing.

FIG. 12—Navigation, SLAM Mapping & Hazard-Aware Routing

Depicts:
hybrid GNSS+indoor SLAM engine,
obstacle-detection overlays,
hazard-zoning modules,
adaptive rerouting engine,
multi-user/team mapping integration,
cloud-augmented hazard forecasting.

FIG. 13—Multi-sensor Fusion Pipeline

FIG. 13 illustrates an embodiment of the multi-sensor fusion pipeline used within the LIFE Vision One system. Primary sensors (801), secondary sensors (802), and accessory-input devices (803) independently supply heterogeneous sensor data, including optical information, depth and motion signals, environmental readings, and gesture-based accessory data. A Temporal Alignment Engine (804) synchronizes these asynchronous inputs by correcting timestamp offsets, sensor-drift variation, and motion-profile discrepancies. The aligned data streams are processed by the Sensor Fusion Core (805), which generates a unified, probabilistic environmental model. The fused output is then provided to the system s AR Neural Rendering engine, which interprets spatial context, predicts hazard vectors, and aligns augmented-reality overlays for real-time visualization.

### DETAILED DESCRIPTION OF THE INVENTION

### Merged From Both Uploaded Documents and Corrected for Structure, Clarity, and Legal Strength

Unless stated otherwise, like-numbered reference numerals refer to like elements across the Figures.

The described embodiments are illustrative and non-limiting; alternative configurations may be implemented without departing from the scope of the invention.

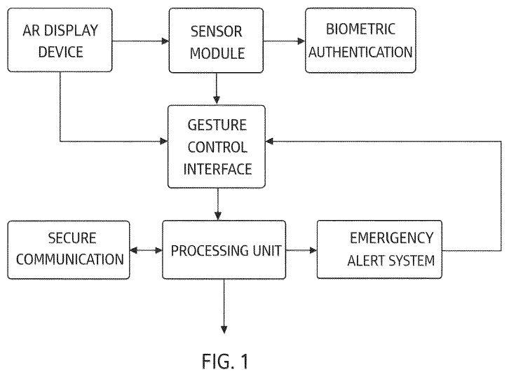

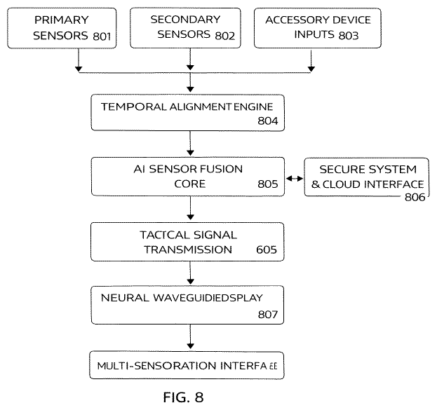

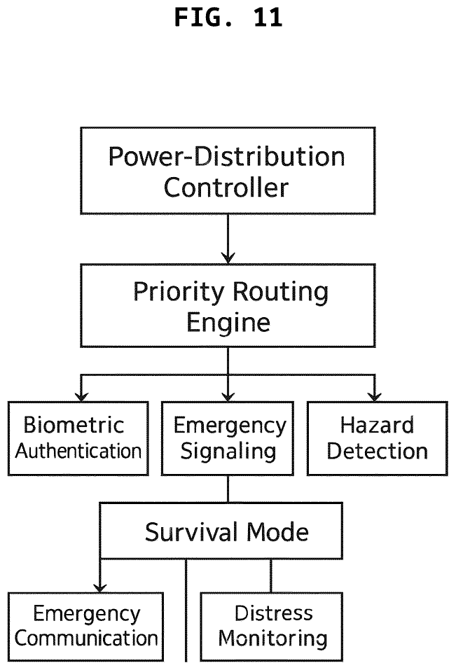

### I. System Overview (refer to FIGS. 1-12)

In one or more embodiments, the invention provides a multi-modal wearable augmented-reality (AR) computing system comprising:
a head-mounted display (HMD),
an adaptive optical system (LIFE Lens),
a sensor-fusion subsystem,
a biometric identity-mapping engine (POIMS),
a gesture-recognition subsystem,
a proximity-verified encrypted communication engine (GIPEP),
an emergency and safety-response subsystem,
a neural-rendering engine,
a navigation and hazard-awareness subsystem, and
a cloud-connected distributed computing layer.

The system is configured to deliver real-time environmental interpretation, continuous biometric authentication, context-aware AR overlays, secure proximity communication, emergency automation, and multi-device orchestration.

The invention may operate as a standalone wearable or as part of a distributed computing ecosystem including:
the LIFE Ring gesture accessory,
the AirPen 3D trajectory input device,
modular sensor attachments,
paired devices (phones, tablets, wrist-wear), and
cloud inference servers.

### II. Core Hardware Architecture

### A. Structural Frame and Housing (Refer to FIG. 1)

In one embodiment, the HMD includes a lightweight, reinforced structural frame housing:

### 1. Processing Bay

multi-core application processor,
neural-acceleration coprocessor,
low-power microcontroller.

These processors coordinate AR rendering, biometric loops, emergency logic, gesture routing, and cloud-sync operations.

### 2. Distributed Battery Modules

Curved micro-cell batteries embedded within the temple arms provide:
balanced weight distribution,
optimized heat dispersion,
uninterrupted power delivery.

A power-governance controller manages:
dynamic load allocation,
emergency battery preservation,
thermal throttling,
wireless/proximity charging.

### 3. Thermal Management System

Includes:
micro-venting pathways,
heat-diffusion strips,
predictive thermal throttling algorithms.

### 4. Connectivity & Expansion Ports

Supports:
modular sensor expansion,
proximity charging nodes,
NFC/UWB antennas,
magnetic docking interfaces for accessories.

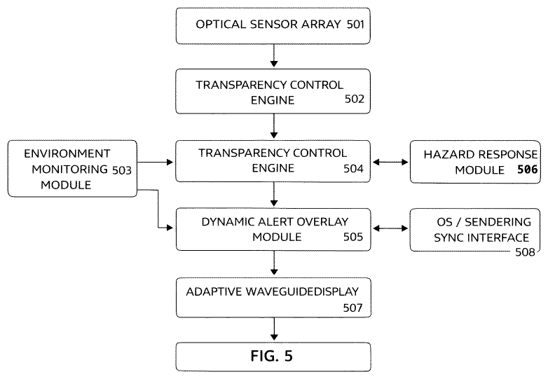

### III. Adaptive Optical System-Life Lens (Refer to FIG. 5)

The optical system includes a multi-layer adaptive lens assembly comprising:
a transparent substrate,
electrochromic opacity layer,
holographic waveguide for AR light injection,
eye-tracking sensors,
thermal-regulation layers,
anti-glare and high-brightness filters.

### A. Optical Behavior

The system modulates optical characteristics in real time based on:
ambient-light conditions,
user stress or fatigue indicators,
emergency triggers,
environmental hazards detected by the sensor-fusion engine.

### B. Forced-Transparency Safety Mode

During high-risk events such as:
operating a vehicle,
smoke or low-visibility environments,
rapid user motion,
panic or distress states detected by POIMS,
the optical system automatically increases transparency to ensure maximum visibility.

### C. Precision AR Alignment

Eye-tracking sensors and lens-position calibration logic maintain correct alignment of:
AR overlays,
hazard indicators,
navigation cues,
gesture-controlled UI elements.

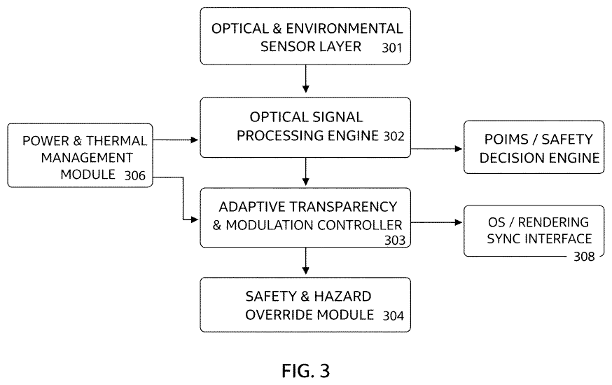

### IV. Multi-Sensor Fusion Engine (refer to FIG. 3)

The sensor-fusion engine synchronizes heterogeneous data sources including:
Primary Sensors
forward-facing RGB cameras,
depth sensors (ToF, LiDAR, stereoscopic),
infrared arrays,
optical-flow sensors,
an Inertial Measurement Unit (IMU) with gyroscope, accelerometer, magnetometer, environmental hazard sensors (air quality, heat, sound pressure anomalies, structural vibration).

### Secondary Sensors

LIFE Ring motion vectors,
AirPen spatial trajectories,
modular sensor-expansion modules,
cloud-returned inference signals,
peer device sensor contributions.

### Temporal Synchronization

A temporal-alignment pipeline resolves:
frame-rate disparities,
inertial drift,
jitter,
cloud-return latency.

### Unified Environmental Model

The fusion engine generates:
spatial maps,
object classification,
hazard prediction,
motion-vector forecasting,
gesture-context disambiguation.

This unified model supports AR placement, navigation accuracy, and emergency logic.

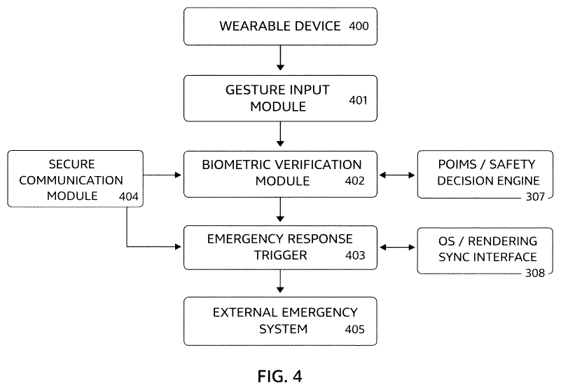

### V. Biometric Authentication Engine—POIMS (Refer to FIG. 4)

The Poly-Observable Identity Mapping System (POIMS) provides continuous biometric authentication using multiple parallel modalities.

### A. Primary Biometric Inputs

ocular-pattern mapping (iris structure, scleral patterns),
vascular-light signature mapping (PPG/NIR-based),
blink-pattern analysis,
gaze-micro-movement behavior,
pupil dynamics and stress indicators,
consciousness-state inference.

### B. Continuous Identity Loop

The system verifies identity every 0.5-2 seconds through:
low-frequency identity checks,
high-frequency checks during security-sensitive actions,
automatic relocking upon device removal or anomalous behavior.

### C. Anti-Spoofing Measures

POIMS rejects:
static images,
videos,
masks,
prosthetic overlays,
artificially projected IR patterns.

### D. Distress Detection

Biometric patterns that indicate:
panic,
micro-sleep,
oxygen deficiency,
impaired consciousness,
trigger emergency monitoring states.

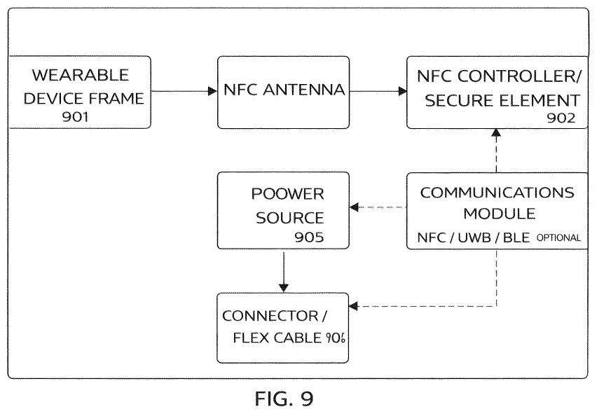

### VI. Gesture-Interaction Framework (Refer to FIG. 9)

The gesture system merges input from three major sources:

### 1. Frame-Mounted Gesture Sensors

IR cameras,
depth micro-gesture detectors,
hand-skeletal tracking.

### 2. LIFE Ring Accessory

Captures:
finger-curl vectors,
squeeze-pressure patterns (including silent SOS),
rotational gestures,
directional motion vectors.

### 3. AirPen Stylus

Supports:
3D air-writing,
high-fidelity spatial annotations,
tactical formations,
medical triage marking.

### Unified Gesture Router

Prioritizes commands based on:
environmental context,
hazard proximity,
user attention state,
biometric confirmation (POIMS),
gesture intensity/clarity.

### VII. Proximity-Verified Communication—GIPEP (Refer to FIGS. 4 & 8)

The Gesture-Initiated, Proximity-Encrypted Protocol (GIPEP) is a novel communication method requiring:
a verified gesture,
a physical proximity threshold,
a biometric identity confirmation,
before establishing a secure communication channel.

### A. Session Key Generation

A short-lived encryption key is generated only when all three conditions are satisfied.

### B. Prevents Unauthorized Access

GIPEP mitigates:
relay attacks,
remote-hijacking attempts,
invisible pairing attempts,
unauthorized interception.

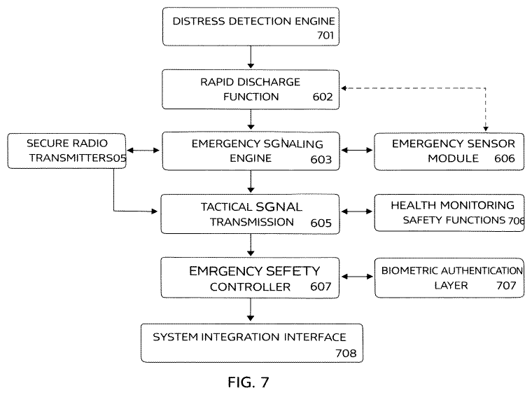

### VIII. Emergency-Response Subsystem—SERS (Refer to FIG. 7)

The Safety & Emergency Response Subsystem (SERS) operates independently on a secure microcontroller to maintain emergency capabilities even during system failure.

### A. Emergency Triggers

Triggers include:
biometric distress,
silent emergency gestures,
abnormal motion patterns,
impacts and falls,
environmental hazards (heat, smoke, chemicals, gas, vibration).

### B. SOS Determination Framework

Two-tiered system:
Silent Confirmation Tier: micro-haptics+micro-opacity cues
Intent Verification Tier: stress correlation+repeated gesture mapping

### C. Emergency Activation Levels (1-4)

Stealth Monitoring
Localized User Alert
Active SOS Broadcast
Autonomous Survival Routing

### D. Fail-Safe Operation

Even at <1% battery, SERS maintains:
SOS signaling,
location bursts,
NFC emergency broadcast,
limited AR survival overlays.

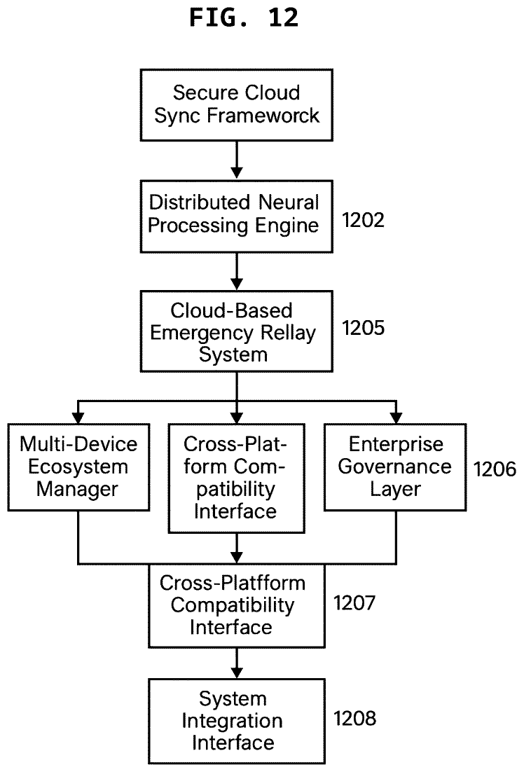

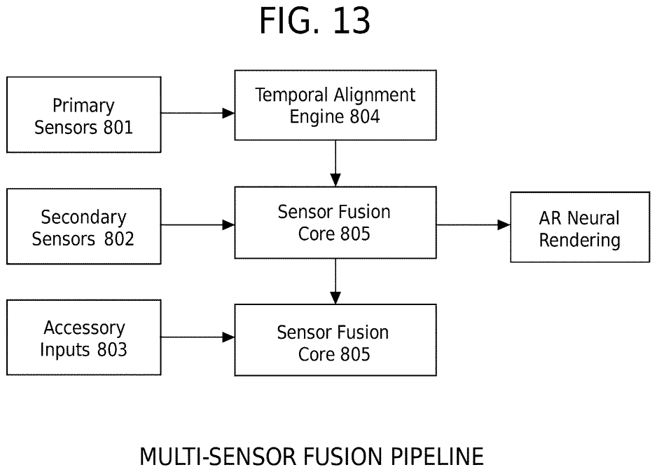

### IX. Navigation, Slam & Hazard-aware Routing (refer to FIG. 12)

### A. Spatial Mapping Engine

Performs:
multi-sensor SLAM,
3D occupancy map generation,
semantic labeling.

### B. Obstacle Detection

Detects:
transparent surfaces,
moving objects,
elevation changes,
drop-offs and hazards.

### C. Hazard Detection

Identifies:
heat sources,
toxic air,
vibration (collapse risk),
smoke density,
electrical anomalies.

### D. Dynamic Routing

Provides:
fastest route,
safest route,
stealth route,
hazard-avoidance route.

### E. Accessibility Modes

Includes:
high-contrast overlays,
haptic-only navigation,
spatial audio panning,
reduced cognitive load UI.

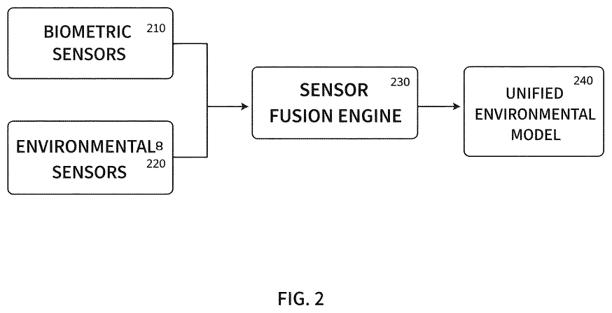

### X. Neural-Rendering Engine (refer to FIGS. 2 & 6)

The system includes a neural-rendering engine configured to process sensor-fusion outputs into real-time visual, auditory, and contextual AR overlays.

### A. Neural Inference Capabilities

The engine supports:

### Predictive Hazard Rendering

Models future hazard vectors (e.g., approaching vehicles, structural instability).
Generates color-coded overlays.

### Object & Entity Understanding

Classifies vehicles, people, tools, weapons, signage.
Creates semantic boundaries for safe navigation.

### Spatial Memory Persistence

Maintains a short-term 3D memory of the environment.
Supports occlusion handling and multi-user shared views.

### Gesture Prediction & Interpretation

Predictive motion forecasting

### Latency Compensation Through Temporal Interpolation

### B. Rendering Adjustments Based on User State

POIMS biometric signals guide:
opacity changes,
overlay reduction in high-stress events,
hazard-only mode during emergencies.

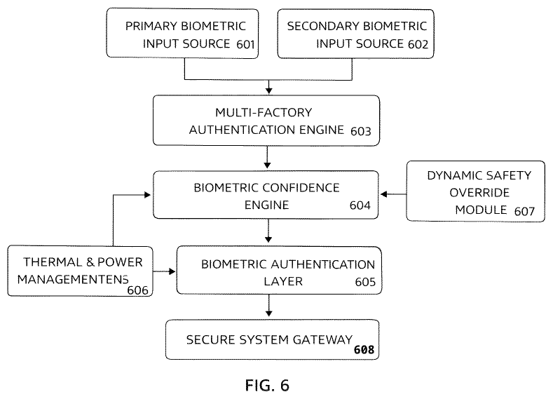

### XI. LIFENode OS—Software Architecture (Refer to FIG. 6)

The system operates under a proprietary operating system (LIFENode OS) comprising:

### A. Real-Time Kernel

Handles:
AR timing windows,
sensor synchronization,
emergency preemption,
safety-critical thread priority.

### B. App Layer

A sandboxed environment where:
third-party apps,
internal tools,
optional modules
operate without interfering with core biometric or emergency logic.

### C. Security Gatekeeper Layer

Controls:
biometric-gated permissions,
data-access constraints,
gesture-lock triggers,
zero-trust enforcement.

### D. Distributed Computing Interface

Supports:
cloud inference,
edge offloading,
device federation,
team-wide mapping integrations.

### XII. Communication Stack (Refer to FIGS. 4 & 8)

A. Proximity-Validated Channels

Include:
GIPEP,
NFC identity bursts,
UWB secure ranging,
authenticated handshake layers.

### B. Conventional Channels

Support:
Bluetooth LE,
Wi-Fi 6/7,
cellular tethering.

### C. Zero-Trust Security

Every communication session is:
identity-confirmed,
gesture-verified,
proximity-matched,
cryptographically time-bound.

This prevents data interception, unauthorized pairing, and remote spoofing.

### XIII. Modular Sensor Expansion Architecture

### A. Expansion Ports

Hot-swappable modules attach magnetically and authenticate through:
POIMS identity confirmation,
secure expansion-bus handshake.

### B. Supported Modules

Examples include:
night-vision sensor cluster,
medical triage modules (SpO2, ECG patch-pairing),
industrial air-quality modules,
tactical thermal imaging module,
radiation/chemical hazard sensors.

### C. Cross-Device Sync

Expansion module data is incorporated into:
sensor-fusion maps,
team overlays,
hazard-routing engines.

### XIV. Cloud-Assisted Distributed Intelligence

The system interfaces with localized servers, cloud nodes, and paired mobile devices to extend real-time intelligence.

### A. Cloud Functions

hazard forecasting,
long-range routing,
multi-user mapping fusion,
heavy ML inference tasks.

### B. Latency Management

The OS predicts:
motion,
gesture endpoints,
environmental transitions
to offset cloud delay.

### C. Hybrid Offline Mode

If cloud service fails:

local neural models continue operating,
SERS remains fully functional,
survival-mode overlays activate.

### XV. User Interface (UI) & Haptic Systems

### A. AR Interface Layers

Include:
smart labels,
contextual pop-ups,
hazard zones,
tactical overlays,
navigation arrows,
biometric status indicators.

### B. Spatial Audio

Supports:
directional cues,
proximity alerts,
emergency tones,
accessibility-guided navigation.

### C. Haptics

Provided by:
temple-arm haptic array,
LIFE Ring haptic motor,
AirPen micro-haptics.

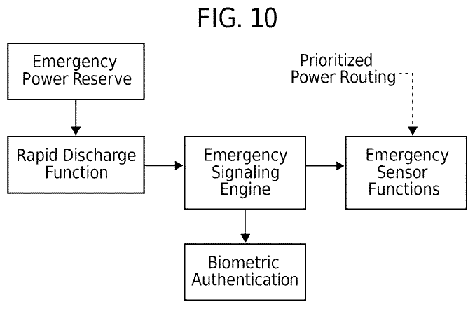

### XVI. Power Architecture & Survival Systems (refer to FIG. 10)

### A. Multi-Cell Battery

Curved micro-cells provide:
distributed weight,
thermal balance,
emergency reserve cell isolation.

### B. Power Control Logic

Manages:
peak-load distribution,
emergency-mode isolation,
wireless charging intake.

### C. Survival Mode (<1% Battery)

Maintains:
SOS bursts,
hazard-only overlays,
location reporting,
incoming responder authentication.

### XVII. Zero-Trust Security Framework

### A. Continuous Biometric Locking

POIMS acts as the root of trust.

If identity fails:
AR overlays disable,
communication locks,
emergency-only mode remains active.

### B. Gesture+Biometric Dual-Factor

No sensitive command executes unless:
a verified gesture and
a valid biometric match
occur together.

### C. Proximity Layer

Ensures commands, data-sharing, and device access are physically intentional.

### XVIII. Example Embodiments & Use Cases

### 1. Emergency Fall Detection & Rescue

User collapses.
IMU detects rapid descent.
POIMS detects distress.
SERS activates Level 3 or Level 4.
Silent broadcast sent to responders.
LIFE Lens shifts to hazard-only overlays.

### 2. Tactical Team Coordination

Multiple users share fused maps.
GIPEP enables secure, proximity-verified data exchange.
Hazard boundaries update in real time.

### 3. Industrial Safety

Sensor modules detect toxic gases.
LIFE Lens opacity adjusts for visibility.
Hazard-aware routing directs user to safe zones.

### 4. Medical Triaging

AirPen allows 3D annotations over patients.
Vital modules pair instantly.
Data transfers only through GIPEP or biometric confirmation.

### 5. Navigation in Low-Visibility Environments

Smoke or fog reduces visibility.
Life Lens force-transparency enables safe movement.
Spatial audio guides route.

### XIX. Alternative Embodiments

Any of the systems described may be implemented:
with alternate sensor combinations,
in visor or helmet-mounted architectures,
with simplified POIMS modules,
with expanded accessory ecosystems,
with scaled versions for consumer, medical, industrial, or tactical use.

### Independent Claim 1—Wearable AR System

A wearable augmented-reality computing system, comprising:
a head-mounted display including an adaptive optical subsystem configured to modulate transparency based on environmental conditions;
a sensor-fusion engine configured to generate a unified environmental model from a plurality of sensors including at least one optical camera, one depth sensor, one inertial measurement unit, and one biometric sensor;
a biometric identity-mapping engine configured to perform continuous user authentication based on ocular, vascular, or micro-movement biometric signals;
a gesture-recognition subsystem configured to interpret user gestures generated by at least one of frame-mounted sensors, a gesture accessory, or a 3D stylus device;
a proximity-verified encrypted communication module configured to initiate secure data exchange only upon detection of a verified gesture, a biometric confirmation, and a physical-proximity threshold; and
an emergency-response subsystem configured to detect distress conditions and autonomously trigger at least one emergency action based on biometric, motion, or environmental data.

### Independent Claim 2—Method of Multimodal AR Operation

A method of operating a multimodal augmented-reality system, the method comprising:
continuously receiving sensor data from a plurality of environmental, biometric, and motion sensors;
generating a unified environmental model using a temporal-synchronization and sensor-fusion process;
performing continuous biometric authentication using ocular, vascular, or behavioral biometric signals;
interpreting user gestures using at least one frame-mounted sensor, gesture accessory, or spatial-input device;
adjusting augmented-reality display transparency, overlays, or alignment in response to user state or environmental hazards; and
initiating an emergency-response procedure upon detecting distress conditions through combined biometric, motion, and environmental signals.

### Independent Claim 3—Gesture-Initiated Proximity-Encrypted Communication

A secure communication protocol for a wearable computing device, comprising:
detecting a user-initiated gesture using a gesture-recognition subsystem;
determining that a communicating device is within a preset physical-proximity threshold;
verifying user identity using continuous biometric authentication;
generating a session-specific encryption key based on the gesture, proximity data, and biometric confirmation; and
establishing an encrypted communication channel only when all three conditions are satisfied.

### Dependent Claims (14 TOTAL)

### Dependent on Claim 1 (Device Claims)

The system of claim 1, wherein the adaptive optical subsystem comprises a holographic waveguide and an electrochromic layer configured to change opacity in less than 50 milliseconds.

The system of claim 1, wherein the biometric identity-mapping engine analyzes at least one of blink-frequency patterns, gaze-micro-movement trajectories, or pupil-dilation vectors.

The system of claim 1, wherein the gesture-recognition subsystem further receives gesture vectors from a ring-type accessory having rotational, pressure, or directional motion sensors.

The system of claim 1, wherein the emergency-response subsystem includes a silent-SOS feature activated by a micro-gesture detectable only by the gesture-recognition subsystem.

The system of claim 1, wherein the sensor-fusion engine further incorporates environmental data from a modular sensor-expansion device magnetically attached to the head-mounted display.

The system of claim 1, wherein the adaptive optical subsystem automatically increases transparency in response to detected smoke, fog, glare, or rapid-motion hazard events.

The system of claim 1, wherein the emergency-response subsystem is configured to operate on a dedicated low-power microcontroller independent of a primary processor.

### Dependent on Claim 2 (Method Claims)

The method of claim 2, further comprising predicting future hazard vectors using neural inference based on motion patterns, object trajectories, or environmental-risk indicators.

The method of claim 2, wherein biometric authentication includes detecting changes in user stress, fatigue, or impaired consciousness.

The method of claim 2, further comprising generating adaptive navigation overlays including hazard-aware routing, obstacle boundaries, or multi-user team coordination markers.

The method of claim 2, further comprising triggering a survival-mode operation that maintains limited emergency functionality when a battery reserve falls below a threshold value.

### Dependent on Claim 3 (Protocol/Security Claims)

The secure communication protocol of claim 3, wherein proximity verification is performed using ultra-wide band ranging, near-field communication, or short-range radio frequency signals.

The secure communication protocol of claim 3, wherein the session-specific encryption key expires after completion of a gesture-verified data exchange.

The secure communication protocol of claim 3, further comprising denying communication when biometric patterns indicate duress, coercion, or impaired consciousness.

### ABSTRACT

A wearable augmented-reality computing system integrates an adaptive optical subsystem, multimodal sensor-fusion engine, biometric authentication, gesture-interaction framework, proximity-verified encrypted communication protocol, and autonomous emergency-response subsystem. The head-mounted display provides dynamic transparency control and waveguide-based AR projection. A biometric identity engine authenticates the user through ocular, vascular, or behavioral signals. A sensor-fusion processor generates a unified environmental model from optical, depth, motion, environmental, and accessory inputs. A gesture-recognition system interprets micro-gestures, ring-based vectors, and spatial-stylus motion. Secure communication is established only after verified gestures, biometric confirmation, and a proximity threshold. Emergency capabilities include distress detection, silent SOS activation, hazard-aware routing, survival-mode power allocation, and authenticated responder access. The system further supports cloud-assisted neural rendering, modular sensor expansion, and distributed multi-user mapping to enhance safety, communication, and real-time AR operation.

1. A wearable augmented-reality computing system, comprising: a head-mounted display including an adaptive optical subsystem configured to modulate transparency based on environmental conditions; a sensor-fusion engine configured to generate a unified environmental model from a plurality of sensors including at least one optical camera, one depth sensor, one inertial measurement unit, and one biometric sensor; a biometric identity-mapping engine configured to perform continuous user authentication based on ocular, vascular, or micro-movement biometric signals; a gesture-recognition subsystem configured to interpret user gestures generated by at least one of frame-mounted sensors, a gesture accessory, or a three-dimensional stylus device; a proximity-verified encrypted communication module configured to initiate secure data exchange only upon detection of a verified gesture, a biometric confirmation, and a physical-proximity threshold; and an emergency-response subsystem configured to detect distress conditions and autonomously trigger at least one emergency action based on biometric, motion, or environmental data.

2. A method of operating a multimodal augmented-reality system, the method comprising: continuously receiving sensor data from a plurality of environmental, biometric, and motion sensors; generating a unified environmental model using a temporal-synchronization and sensor-fusion process; performing continuous biometric authentication using ocular, vascular, or behavioral biometric signals; interpreting user gestures using at least one frame-mounted sensor, gesture accessory, or spatial-input device; adjusting augmented-reality display transparency, overlays, or alignment in response to user state or environmental hazards; and initiating an emergency-response procedure upon detecting distress conditions through combined biometric, motion, and environmental signals.

3. A secure communication protocol for a wearable computing device, comprising: detecting a user-initiated gesture using a gesture-recognition subsystem; determining that a communicating device is within a preset physical-proximity threshold; verifying user identity using continuous biometric authentication; generating a session-specific encryption key based on the gesture, proximity data, and biometric confirmation; and establishing an encrypted communication channel only when all three conditions are satisfied.

4. The system of claim 1, wherein the adaptive optical subsystem comprises a holographic waveguide and an electrochromic layer configured to change opacity in less than 50 milliseconds.

5. The system of claim 1, wherein the biometric identity-mapping engine analyzes at least one of blink-frequency patterns, gaze-micro-movement trajectories, or pupil-dilation vectors.

6. The system of claim 1, wherein the gesture-recognition subsystem further receives gesture vectors from a ring-type accessory having rotational, pressure, or directional motion sensors.

7. The system of claim 1, wherein the emergency-response subsystem includes a silent-SOS feature activated by a micro-gesture detectable only by the gesture-recognition subsystem.

8. The system of claim 1, wherein the sensor-fusion engine further incorporates environmental data from a modular sensor-expansion device magnetically attached to the head-mounted display.

9. The system of claim 1, wherein the adaptive optical subsystem automatically increases transparency in response to detected smoke, fog, glare, or rapid-motion hazard events.

10. The system of claim 1, wherein the emergency-response subsystem is configured to operate on a dedicated low-power microcontroller independent of a primary processor.

11. The method of claim 2, further comprising predicting future hazard vectors using neural inference based on motion patterns, object trajectories, or environmental-risk indicators.

12. The method of claim 2, wherein biometric authentication includes detecting changes in user stress, fatigue, or impaired consciousness.

13. The method of claim 2, further comprising generating adaptive navigation overlays including hazard-aware routing, obstacle boundaries, or multi-user team coordination markers.

14. The method of claim 2, further comprising triggering a survival-mode operation that maintains limited emergency functionality when a battery reserve falls below a threshold value.

15. The secure communication protocol of claim 3, wherein proximity verification is performed using ultra-wide band ranging, near-field communication, or short-range radio frequency signals.

16. The secure communication protocol of claim 3, wherein the session-specific encryption key expires after completion of a gesture-verified data exchange.

17. The secure communication protocol of claim 3, further comprising denying communication when biometric patterns indicate duress, coercion, or impaired consciousness.
